(19) United States
(12) Patent Application Publication
(10) Pub. No.: US 2022/0378242 A1
(43) Pub. Date: Dec. 1, 2022

(54) POUR-OVER COFFEE SYSTEM

(71) Applicant: BRADSHAW HOME, Rancho Cucamonga, CA (US)

(72) Inventor: Christopher Warren GLUPKER, North Hills, CA (US)

(73) Assignee: BRADSHAW HOME, Rancho Cucamonga, CA (US)

(21) Appl. No.: 17/334,401

(22) Filed: May 28, 2021

(51) Int. Cl. A47J 31/02; A47J 31/06

(52) U.S. Cl. CPC A47J 31/02; A47J 31/0626

(57) ABSTRACT

A pour-over beverage system includes a dripper and a water reservoir stackable on the dripper. The dripper may include a receptacle having a bottom wall having an elliptical perimeter, a sidewall extending upward from the bottom wall to define an opening of the receptacle, the opening being circular, and a plurality of ridges on the sidewall. The dripper also includes a base extending outward from the bottom wall. The water reservoir includes a reservoir bottom wall, a plurality of first through-holes spaced about a center of the reservoir bottom wall, a plurality of second through-holes spaced about the center of the reservoir bottom wall such that the first through-holes are closer to the center of the reservoir bottom wall than the second through-holes are to the center of the reservoir bottom wall, and a reservoir sidewall extending upward from bottom wall to define an opening of the water reservoir.

### BACKGROUND OF THE DISCLOSURE

### 1. Field of the Disclosure

The present disclosure is directed to a pour-over coffee system, and, more particularly, a pour-over coffee system with improved water flow.

### 2. Description of Related Art

There are many different types of coffee brewing systems available on the market. These systems can be used to brew full pots of coffee down to individual servings. Many electrical brewing systems designed to brew individual servings work with individually pre-packaged coffee containers. These individually pre-packaged coffee containers are often made of plastic. Such systems often result in accumulated waste over time as the plastic containers are often thrown away after a single use. A popular alternative to these pre-packaged coffee containers are pour-over coffee systems that use a paper filter instead of plastic. As such, these pour-over coffee systems can be more environmentally friendly than the electrical brewing systems.

A typical pour-over system has a dripper designed to rest on the opening of a beverage container. After a filter has been placed in the dripper and ground coffee has been placed in the filter, heated water is poured over the ground coffee. The heated water slowly flows out of the dripper after contacting the ground coffee into the beverage container.

When just a dripper is used, it may be difficult to control how much coffee is brewed because the quantity of water is unknown. As such, some pour-over systems provide a water reservoir designed to cooperate with the dripper. However, even if a water reservoir is provided, they typically distribute the heated water to a central location in the dripper. As a result, the water flowing through the filter may be concentrated in that location and not all of the ground coffee is utilized.

### BRIEF SUMMARY OF THE DISCLOSURE

Accordingly, an object of the present disclosure is to address drawbacks in the conventional pour-over brewing system by providing a water reservoir and dripper that improve the interaction between the heated water and the ground coffee.

Another object of the present disclosure is to provide a pour-over brewing system that may be used with many different sized beverage containers ranging from individual coffee cups to large mugs with sealable lids.

To achieve this and other advantages and in accordance with the purpose of the present disclosure, as embodied and broadly described herein, in one aspect a pour-over beverage system is provided that may include a dripper and a water reservoir stackable on the dripper. The dripper may include a receptacle to hold a filter. The receptacle may include a bottom wall having an elliptical perimeter, a sidewall extending upward from the bottom wall to define an opening of the receptacle, the opening being circular, and a plurality of ridges on the sidewall. The dripper may also include a base extending outward from the bottom wall. The base may be configured to support the dripper on various sized beverage containers. The water reservoir may be stackable on the opening of the receptacle, and the water reservoir may include a bottom wall, a plurality of first through-holes in the bottom wall, the first through-holes being spaced about a center of the bottom wall, a plurality of second through-holes in the bottom wall, the second through-holes being spaced about the center of the bottom wall such that the first through-holes are closer to the center of the bottom wall than the second through-holes are to the center of the bottom wall, and a sidewall extending upward from bottom wall to define an opening of the water reservoir.

In another aspect, the first through-holes may be equally spaced from the center of the bottom wall of the water reservoir. The first through-holes may also be equally spaced in a circumferential direction about the center of the bottom wall.

In a further aspect, the second through-holes may be equally spaced in the circumferential direction about the center of the bottom wall of the water reservoir. The second through-holes may be offset with respect to the first through-holes in the circumferential direction about the center of the bottom wall of the water reservoir.

In yet another aspect, the bottom wall of the water reservoir may be faceted to define a plurality of first wells and a plurality of second wells. The first wells may be deeper than the second wells. Each of the first through-holes may be located in a corresponding first well of the first wells, and each of the second through-holes may located in a corresponding second well of the second wells.

In a different aspect, the base of the dripper may have a circular perimeter.

In still another aspect, the sidewall of the dripper may have a first portion extending normal to the bottom wall of the dripper and a second portion may be angled outward from the first portion. The ridges may extend along the first portion and the second portion. The ridges may not extend on to the bottom wall.

In yet another aspect, the bottom wall of the dripper may include a nozzle at a center thereof. The bottom wall may also include a pair of ribs on opposite sides of the nozzle.

In a further aspect, the dripper may include a ring member extending down from the bottom wall with the nozzle being located at a center of the ring member. The dripper may also include a plurality of ribs extending radially from the ring member towards a perimeter of the base.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure. In the drawings:

FIG. 1 is a perspective view of the pour-over brewing system according to an exemplary embodiment of the present disclosure;

FIG. 2 is an elevation view of the pour-over brewing system of FIG. 1;

FIG. 3 is a plan view of the pour-over brewing system of FIG. 1;

FIG. 4 is a sectional view of the pour-over brewing system take along line 4-4 of FIG. 3;

FIG. 5 is a perspective view of a water reservoir of the pour-over brewing system of FIG. 1;

FIG. 6 is an elevation view of the water reservoir of FIG. 5;

FIG. 7 is a plan view of the bottom of the water reservoir of FIG. 6;

FIG. 8 is a perspective view of a dripper of the pour-over brewing system of FIG. FIG. 1;

FIG. 9 is a plan view of the dripper of FIG. 8;

FIG. 10 is a plan view of the bottom of the dripper of FIG. 8; and

FIG. 11 is a plan view of the dripper with a filter inserted into the dripper of FIG. 8.

### DETAILED DESCRIPTION OF THE DISCLOSURE

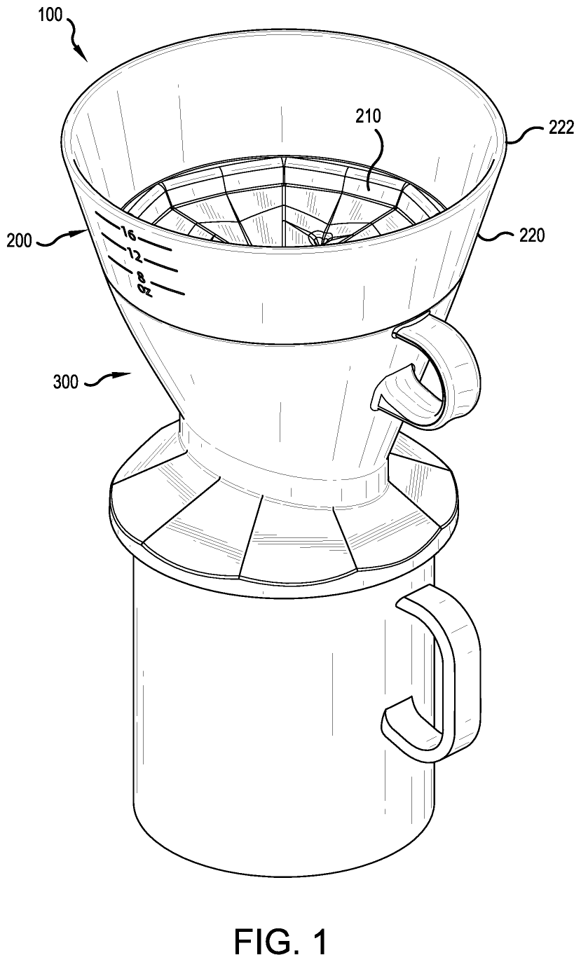

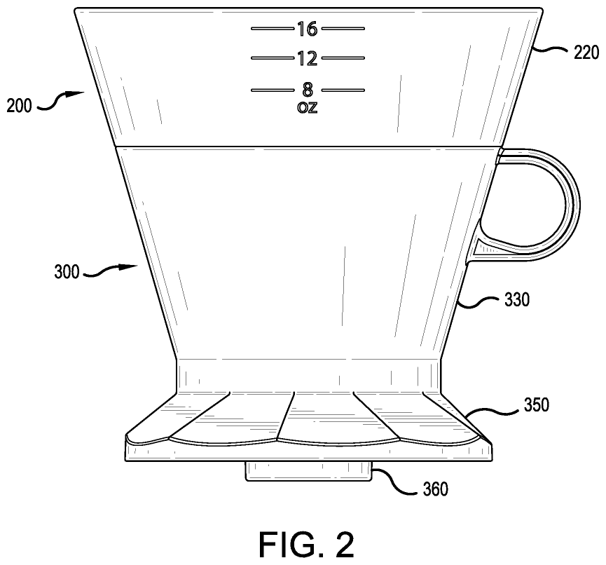

Referring now in detail to the drawings for the purposes of illustrating an exemplary embodiment of the present disclosure, a pour-over brewing system 100 is shown in FIGS. 1-4. The pour-over brewing system 100 includes a water reservoir 200 and a dripper 300. The water reservoir 200 may be made of a plastic, such as, TritanTM from Eastman Chemical, glass, or other suitable materials. The dripper 300 may be made of plastic, such as, polypropylene, or other suitable materials. While the pour-over system 100 is shown placed on a coffee cup, the pour-over system 100 is usable with many different beverage containers.

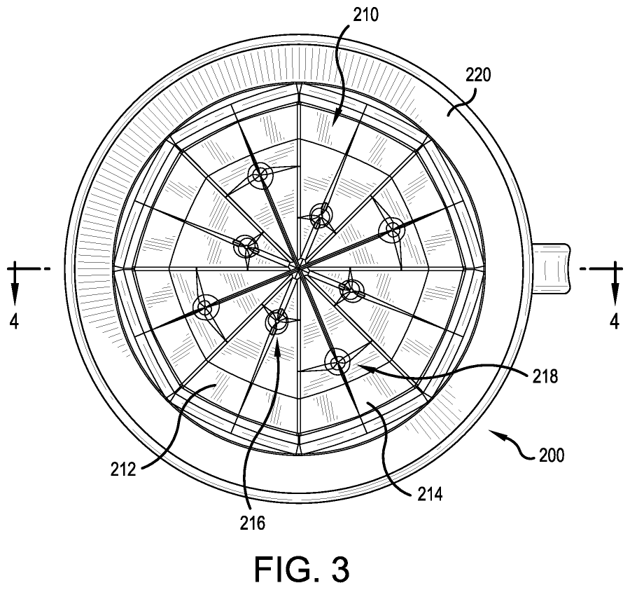

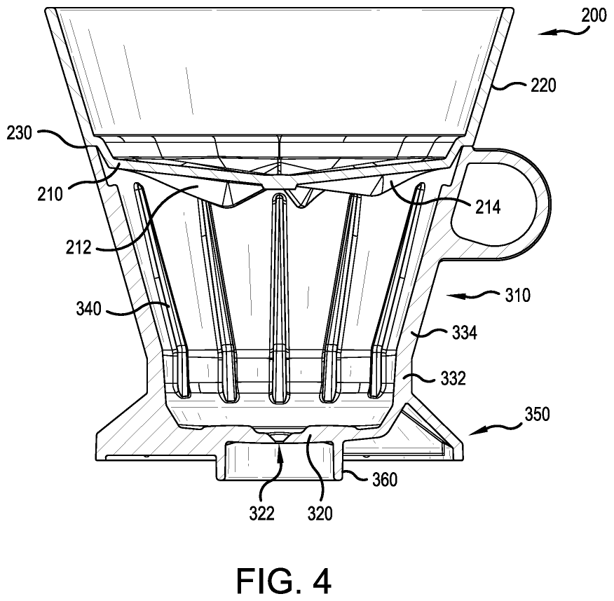

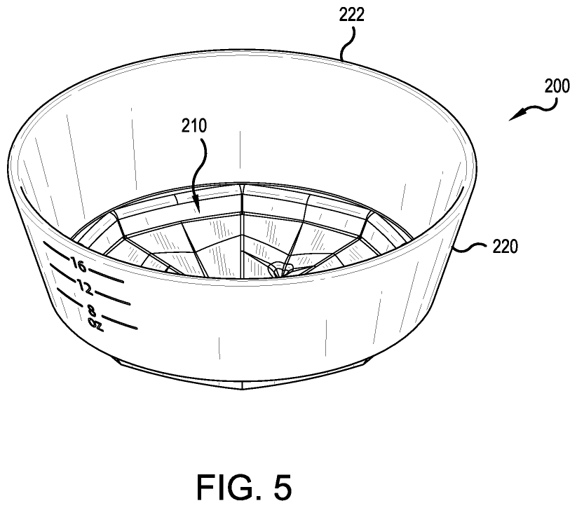

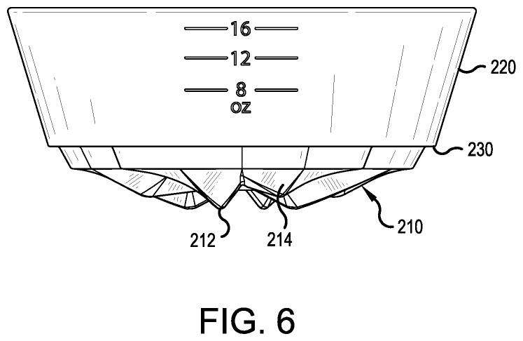

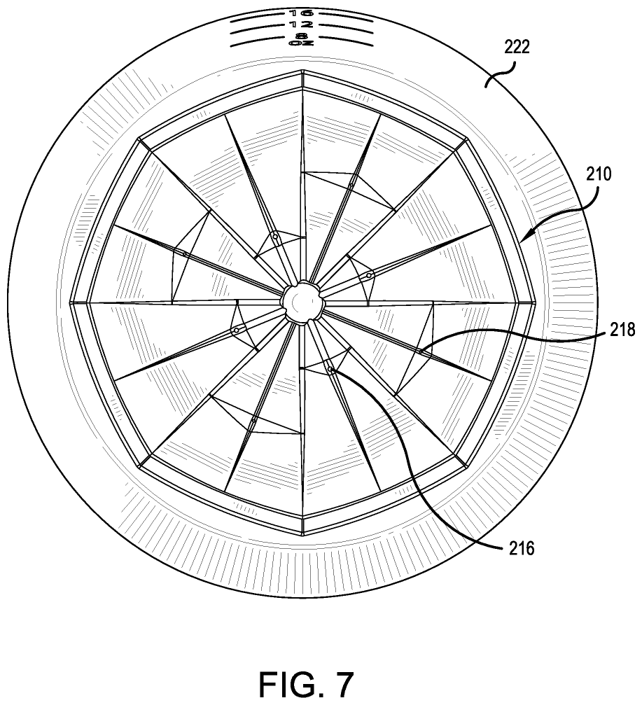

In addition to FIGS. 1-4, particulars of the water reservoir 200 are shown in FIGS. 5-7. The water reservoir 200 has a faceted, bottom wall 210 that defines a plurality of first wells 212 and a plurality of second wells 214. First through-holes 216 are formed in the first wells 212 and second through-holes 218 are formed in the second wells 214. As best seen in FIG. 3, the first through-holes 216 are evenly spaced in a circumferential direction about a center of the bottom wall 210. The second through-holes 218 are also evenly spaced in the circumferential direction about a center of the bottom wall 210 and are off-set with respect to the first through-holes 216 in the circumferential direction about the center of the bottom wall 210. Notably, the first through-holes 216 are closer to the center of the bottom wall 210 than the second through-holes 218 are to the center of the bottom wall 210. The diameters of the first through holes 216 at the lowermost surface of the first wells 212 may be larger than the diameters of the second through holes 218 at the lowermost surface of the second wells 214. In addition, the first through holes 216 and the second through holes 218 may taper as they extend through the bottom wall. As best seen in FIG. 4, the first wells 212 are deeper than the second wells 214. With this arrangement of the first wells 212 and the second wells 214, heated water poured into the water reservoir can be more evenly distributed into the dripper 300 below the water reservoir 200.

The water reservoir 200 also includes a sidewall 220 angled outward from the bottom wall 210 to define an opening 222 through which heated water can be poured into the water reservoir 200. The sidewall 200 can include indica that indicate various volumes for brewing different amount of coffee. In this exemplary arrangement, the indicia indicate 8 oz., 12 oz., and 16 oz. It is understood that the water reservoir is not limited to these volumes. A stepped portion 230 may be provided at the transition from the bottom wall 210 to the sidewall 220 to allow the water reservoir to rest on the dripper 300.

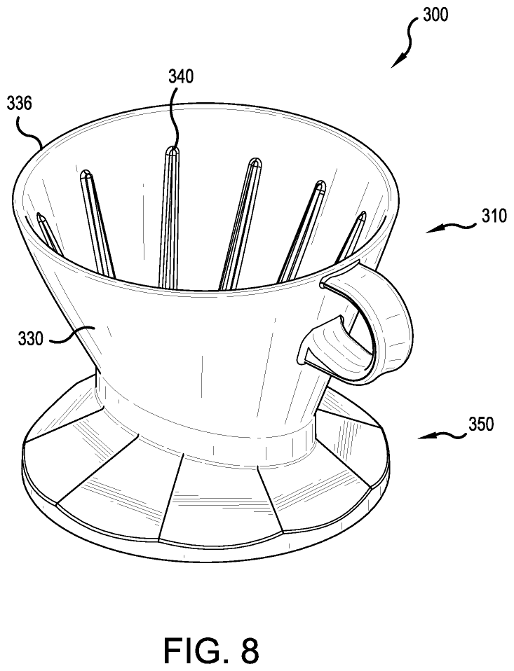

In addition to FIGS. 1-4, particulars of the dripper 300 are shown in FIGS. 8-10. The dripper 300 has a receptacle 310 to hold a paper filter and ground coffee. The receptacle 310 includes a bottom wall 320, a sidewall 330 extending upward from the bottom wall 320 to define an opening 336 of the receptacle, and a plurality of ridges 340 on the sidewall 330. In this arrangement, the bottom wall 320 has an elliptical perimeter and the opening 336 is circular. By providing a transition from a round opening to an elliptical perimeter, many different configurations of paper filters can be accommodated.

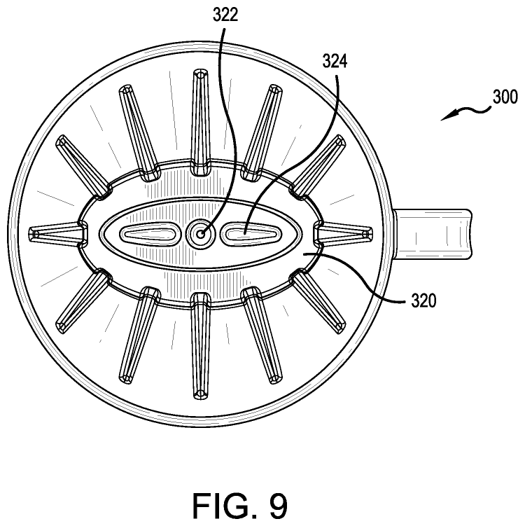

As best seen in FIGS. 4 and 9, the bottom wall 320 includes a nozzle 322 to allow coffee to flow out of the dripper 300 and into a beverage container. A pair of ribs 324 are provided on opposite sides of the nozzle 322. The ribs 324 assist in directing the flow of coffee towards the nozzle 322. In addition, the ribs 324 can assist in preventing a paper filter from resting entirely on the bottom wall 320 and blocking the nozzle 322.

The sidewall 330 has first portion 332 extending normal to the bottom wall and a second portion 334 angled outward from the first portion. The ridges 340 extend along the first portion 332 and the second portion 334 but do not extend onto the bottom wall 320. The ridges 340 prevent the sides of the paper filter from sticking to the sidewall 330, thereby providing space for the coffee to flow through the paper filter and onto the sidewall 330.

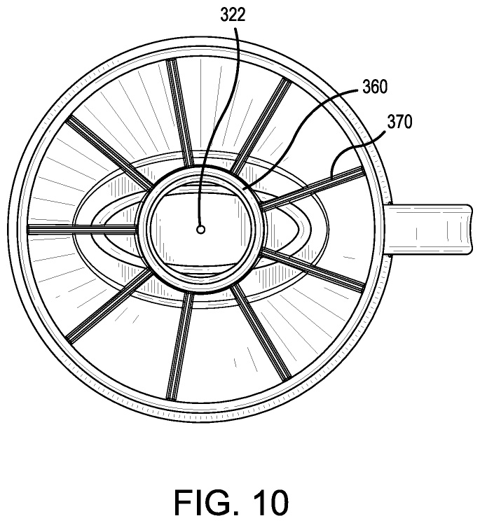

As best seen in FIGS. 4 and 10, the dripper 300 includes a base 350 that extends outward from the bottom wall 320 to allow the dripper to rest on an opening of the beverage container. A ring member 360 also extends down from the bottom wall 320 and encircles the nozzle 322. Because the nozzle is located at a center of the ring member 360, it is possible to better position the nozzle centrally in the opening of the beverage container. That is, the ring member 360 can act as a guide to ensure that the nozzle 322 is disposed above the opening in the beverage container.

The dripper 300 can include a plurality of ribs 370 extending radially outward from the ring member 360 towards the perimeter of the base. The ribs 370 allow the dripper to be stably supported by different sized beverage containers. In addition, by providing a plurality of ribs 370 instead of a solid base, the amount of material of the dripper can be reduced.

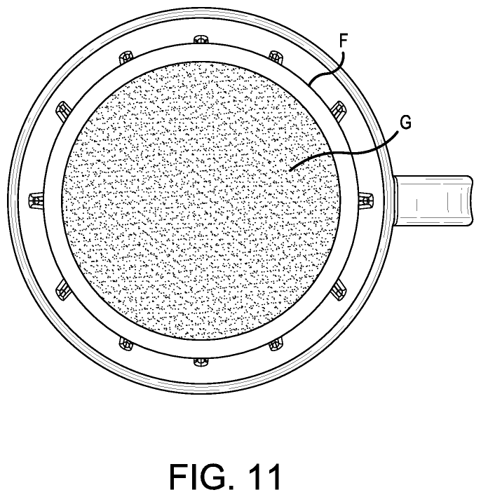

In order to use the dripper, as shown in FIG. 11, a paper filter F can be inserted into the receptacle 310 such that the paper filter F rests on the ridges 340. While the paper filter F is shown with flat sides, the paper filter F can be pleated to increase the surface area of the paper filter F. Ground coffee G is placed in the paper filter F. Then, the dripper 300 may be placed on a beverage container and the water reservoir 200 is stacked on the dripper 300 (FIG. 1). Finally, a desired amount of heated water is poured into the water reservoir 200 such that the heated water may be more uniformly dispersed over the ground coffee.

The pour-over beverage system thus being described, it will be obvious that the same may be varied in many ways. Such variations are not to be regarded as a departure from the spirit and scope of the disclosure, and all such modifications as would be obvious to one skilled in the art are intended to be included within the scope of the following claims.

What is claimed is:

1. A water reservoir for a pour-over beverage system, the water reservoir comprising:
a bottom wall;
a plurality of first through-holes in the bottom wall, the first through-holes being spaced about a center of the bottom wall;
a plurality of second through-holes in the bottom wall, the second through-holes being spaced about the center of the bottom wall such that the first through-holes are closer to the center of the bottom wall than the second through-holes are to the center of the bottom wall; and
a sidewall extending upward from bottom wall to define an opening of the water reservoir.

2. The water reservoir according to claim 1, wherein the first through-holes are equally spaced from the center of the bottom wall.

3. The water reservoir according to claim 2, wherein the first through-holes are equally spaced in a circumferential direction about the center of the bottom wall.

4. The water reservoir according to claim 3, wherein the second through-holes are equally spaced in the circumferential direction about the center of the bottom wall.

5. The water reservoir according to claim 1, wherein the second through-holes are offset with respect to the first through-holes in a circumferential direction about the center of the bottom wall.

6. The water reservoir according to claim 1, wherein the bottom wall is faceted to define a plurality of first wells and a plurality of second wells, and
wherein the first wells are deeper than the second wells.

7. The water reservoir according to claim 6, wherein each of the first through-holes is located in a corresponding first well of the first wells, and
wherein each of the second through-holes is located in a corresponding second well of the second wells.

8. A dripper for a pour-over brewing system, the dripper comprising:
a receptacle to hold a filter, the receptacle including:
a bottom wall having an elliptical perimeter;
a sidewall extending upward from the bottom wall to define an opening of the receptacle, the opening being circular; and
a plurality of ridges on the sidewall,
a base extending outward from the bottom wall, the base being configured to support the dripper on a beverage container.

9. The dripper according to claim 8, wherein the base has a circular perimeter.

10. The dripper according to claim 8, wherein the sidewall has first portion extending normal to the bottom wall and a second portion angled outward from the first portion.

11. The dripper according to claim 10, wherein the ridges extend along the first portion and the second portion.

12. The dripper according to claim 11, wherein the ridges do not extend on to the bottom wall.

13. The dripper according to claim 8, wherein the bottom wall includes a nozzle at a center thereof.

14. The dripper according to claim 13, where the bottom wall includes a pair of ribs on opposite sides of the nozzle.

15. The dripper according to claim 13, further comprising a ring member extending down from the bottom wall, the nozzle being located at a center of the ring member.

16. The dripper according to claim 15, further comprising a plurality of ribs, each rib extending radially from the ring member towards a perimeter of the base.

17. A pour-over beverage system, comprising:
a dripper, the dripper including:
a receptacle to hold a filter, the receptacle including:
a bottom wall having an elliptical perimeter;
a sidewall extending upward from the bottom wall to define an opening of the receptacle, the opening being circular; and
a plurality of ridges on the sidewall,
a case extending outward from the bottom wall, the base being configured to support the dripper on a beverage container; and
a water reservoir stackable on the opening of the receptacle, the water reservoir including:
a reservoir bottom wall;
a plurality of first through-holes in the reservoir bottom wall, the first through-holes being spaced about a center of the reservoir bottom wall;
a plurality of second through-holes in the reservoir bottom wall, the second through-holes being spaced about the center of the reservoir bottom wall such that the first through-holes are closer to the center of the reservoir bottom wall than the second through-holes are to the center of the reservoir bottom wall; and
a reservoir sidewall extending upward from the reservoir bottom wall to define an opening of the water reservoir.

18. The pour-over beverage system according to claim 17, wherein the first through-holes are equally spaced from the center of the reservoir bottom wall and are equally spaced in a circumferential direction about the center of the reservoir bottom wall, and
wherein the second through-holes are equally spaced in the circumferential direction about the center of the reservoir bottom wall and are offset with respect to the first through-holes in a circumferential direction about the center of the reservoir bottom wall.

19. The pour-over beverage system according to claim 17, wherein the ridges extend along the first portion and the second portion, and
wherein the ridges do not extend on to the reservoir bottom wall.
